(19) United States
(12) Patent Application Publication
(10) Pub. No.: US 2013/0132284 A1
(43) Pub. Date: May 23, 2013

(54) System And Method For Management And Deliberation Of Idea Groups

(71) Applicants: Gregorio Convertino, Martina Franca (IT); Lichan Hong, Mountain View, CA (US)

(72) Inventors: Gregorio Convertino, Martina Franca (IT); Lichan Hong, Mountain View, CA (US)

(73) Assignee: PALO ALTO RESEARCH CENTER INCORPORATED, Palo Alto, CA (US)

(21) Appl. No.: 13/300,467

(22) Filed: Nov. 18, 2011

(51) Int. Cl. G06Q 10/00

(52) U.S. Cl. 705/300

(57) ABSTRACT

A system and method for method for management and deliberation of idea groups is provided. Ideas are associated with metadata and stored. The ideas are grouped into aggregated based on the associated metadata. A vote is received for at least one of the aggregates from a user. The vote is distributed among the ideas in that aggregate based on a reputation of the user providing the vote and a centrality of each idea in the aggregate.

### FIELD

This application relates in general to idea management, and in particular, to a system and method for management and deliberation of idea groups.

### BACKGROUND

Business organizations and communities are often inundated with feedback from members regarding the functioning of and direction of their organization or community, and the increase in social media has resulted in even more input from the members. Currently, idea management systems allow the members of a networked organization or community to generate, share, judge, refine, and select ideas. However, with the increase in ideas and feedback, review of the ideas can be time consuming. For example, due to time constraints, members may not be able to review every idea and those ideas most relevant to an organization may not be considered for implementation, which ultimately can lead to sub-optimal idea selection.

Companies that currently provide idea management systems for use in business organizations include, for example, Imaginatik plc, of Boston, Mass.; Spigit of Pleasanton, Calif.; and IdeaScale. Meanwhile, research prototypes, such as Deliberatorium, developed at MIT, and mIPS, developed at the Federal University of Rio de Janeiro, have been used in civic communities.

Imaginatik allows users to share ideas, add comments, and vote on the ideas. The ideas can be reviewed and voted upon using an informal voting process in which all contributors are allowed to vote. Alternatively, a formal voting process is used, which invites only team members to vote. As well, a “5-star” voting process can be implemented, which invites particular members to vote on the ideas anonymously. Each idea is reviewed and voted upon individually, rather than as a grouping of ideas.

Spigit utilizes crowdsourcing to identify innovators from employee input, which is extracted from social networking sites. The employees use Spigit currency to indicate an opinion of each input's likelihood and to reflect predictions regarding the input. The employees are rewarded for good predications and penalized for bad predications. The employee opinions are provided for a single item of input, rather than a group of related input.

IdeaScale collects ideas and feedback from customers of a company using a web-based software platform and brings the conversation and feedback to the company. For example, a customer creates a post, such as an idea, and feedback regarding the post gets developed through comments and votes. The idea can be created via a new idea submission form, which includes predetermined fields. Additionally, custom fields can be added to the submission form. The votes are collected and the posts with the most valuable feedback move to a higher position. Thus, each post is reviewed and voted upon individually, rather than as a grouping with other posts.

Deliberatorium is a large-scale argumentation system, which allows remote users from a networked community to combine their knowledge to identify solutions to problems, including sustainability, climate change policy, and complex product design. Differently from other systems, this type of argumentation system requires users to distinguish issues or questions, ideas or solution, and arguments (pros and cons) and organizes the issues, questions, ideas, solutions, and arguments in a tree-like structure called the argument map. The community members contribute to this structured argument map issues, ideas, or arguments to the structured argument map. Deliberatorium follows a “live and let live” rule, which provides that if a member disagrees with an idea or argument, he should not change the post, but should create a new post. The posted issues, ideas, and arguments are collaboratively refined by, for example, raising an issue, proposing possible ideas or solutions for the issue, and weighting arguments in favor or against for each solution. Other members in the community can rate the posts. Thus, in Deliberatorium, users are focusing on a single issue, idea, or argument at a time, rather than a group of ideas. In this system, the space of ideas (argument map) is more rigidly structured than in the other systems above. For example, the structure tends to remain fixed while the needs of the analysis and the pool of ideas available may vary. This limits how flexibly the corpus of ideas can be dissected and reorganized by users and analysts or facilitators.

mIPS is another argumentation system that focuses on generating ideas for solving a particular issue, then identifying fewer proposals by structuring the ideas, and finally determining which proposal is to be selected. The ideas are refined to determine relationships between two or more ideas, such as whether the ideas are equivalent, complementary, antagonistic, or dependent. A set of ideas are first manually related and then manually consolidated into the proposals for solving the issue. However, the mIPS system does not include specific support for the identification of relationships among ideas or consolidation in proposal. Each user can then vote on one proposal per issue to identify a proposal that most appropriately solves the issue. Yet, the vote is only assigned to the related ideas as a whole and is not distributed among the ideas in the proposal. This system also fails to address the problem of reduced flexibility in how the corpus of ideas can be dissected and reorganized by users, and analysts or facilitators.

Lithium Social Customer Suite by Lithium Technologies, Inc. of Emeryville, Calif., allows customers of a company to engage in discussion on a company's Website via forums and blogs, and to connect with other customers through Facebook, Twitter, and a social platform controlled by the company that allows customers to create, approve, and organize knowledge articles. The customers can post questions and answers, share product knowledge, share innovative ideas, and give feedback regarding a company, which becomes property of the company. The Social Customer Suite can also identify which customers have a large influence on the other customers via reputation engine. However, the platform mainly provides support of knowledge sharing and is not designed to support idea management or collaborative innovation specifically. Also, the content shared is not structured and the identified reputation is computed based on behaviors across different tools, such as blog posts, articles, and tags, rather than specific to idea generation, refinement, or selection.

Dell, Inc. launched IdeaStorm to identify ideas most relevant to the public. Registered users can add, promote, demote, and comment on articles. Articles that are promoted are assigned a higher score and are displayed near a top of a display page, whereas lower ranked articles are considered to be less important and are displayed below the articles with higher scores. Additionally, IdeaStorm uses a “vote half life,” which allows the articles with recent votes to move further up on a display page, past articles with higher scores that are based on older votes. However, the articles are voted upon individually, rather than as a group.

Further, Starbucks, Inc. deployed My Starbucks Idea, which is powered by a software platform by Saleseforce.com, Inc. My Starbucks Idea allows registered partners and customers of Starbucks to post and view ideas, as well as to comment on ideas. The ideas available for review by groups, such as product ideas, experience ideas, and involvement ideas. The registered users are able to view ideas that are most popular, most recent, most commented on, under review, already reviewed, launched, and coming soon. Additionally, each registered user has an inbox for messages, a list of favorite idea, and a user profile. Employees of Starbucks review at least a portion of the ideas individually and provide an outcome of the review, rather than considering a group of related ideas at one time.

Additionally, U.S. Pat. No. 7,533,034, to Laurin et al., provides an idea management system in which users provide structured responses to an idea via a template. Based on the responses, a second template requests information regarding a financial consequence of implementing the idea. The idea is developed through a series of templates and is routed to one or more members of management. Therefore, in Laurin et al., the ideas are individually reviewed, rather than grouping ideas for review and voting.

U.S. Patent Application Publication No. 2011/0093539, also to Laurin et al., provides an environment for innovation and idea management. Users submit ideas and members of the environment comment on the idea. The idea is assigned to a facilitator responsible for performing tasks to advance the idea, such as editing the idea. The idea and data regarding the tasks is published to at least one manager who reviews and rates the idea and data against a set of criteria. Thus, ideas are reviewed and rated individually, rather than as a group of ideas, which are voted upon.

U.S. Pat. No. 7,831,455 to Yoshida et al., provides a Website for voting on submitted ideas. The vote can be weighted based on a time of the vote or style of the vote. Subsequently, votes for each idea are tallied. Therefore, Yoshida et al. discloses voting on individual ideas, rather than on groups of ideas and distributing the vote among the ideas within the group.

U.S. Pat. No. 6,961,756, to Dilsaver et al., provides a central portal, which allows employees to make suggestions to a company. The suggestions are incorporated into central databases that are designated for internal ideas and external solicitations. The suggestions are categorized using keys words. Subsequently, the employees sign up to receive emails that include new ideas are relevant to the employees' interests. Thus, in Dilsaver et al., users receive ideas of interest based on areas of interest, rather than grouping ideas and distributing votes among the ideas in the group.

As described above, each of the existing systems have limitations, which can lead to cognitive overload of the users, allowing ideas to be overlooked, and failing to efficiently reuse knowledge learned from prior decisions due to managing content and voting on the content solely at a level of single ideas. Also, the argumentation systems, such as Deliberatorium and mIPS, which have useful functions for comparing ideas, suffer from reduced flexibility regarding reorganization of a pool of ideas based on needs of the analyst and the available ideas. Thus, a system and method for efficiently managing content and ensuring that good ideas are surfacing by allowing users to flexibly aggregate ideas, vote on the aggregates, and distribute the vote among the ideas of the aggregate is needed.

### SUMMARY

An embodiment provides a system and method for management and deliberation of idea groups. Ideas are associated with metadata and stored. The ideas are grouped into aggregated based on the associated metadata. A vote is received for at least one of the aggregates from a user. The vote is distributed among the ideas in that aggregate based on a reputation of the user providing the vote and a centrality measure of each idea in the aggregate.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a system for management and deliberation of idea groups, in accordance with one embodiment.

FIG. 2 is a method for management and deliberation of idea groups, in accordance with one embodiment.

FIG. 3 is a screenshot showing, by way of example, a Web page for displaying, topics, tags, and people for selection by a user.

FIG. 4 is a screenshot showing, by way of example, a Web page for displaying aggregates of documents based on selected topics and tags.

FIG. 5 is a screenshot showing, by way of example, a Web page for displaying a different aggregate of documents based on selected topics, tags, and people.

FIG. 6 is a screenshot showing, by way of example, a Web page for displaying a user profile.

FIG. 7 is a screenshot showing, by way of example, a Web page for refining aggregates of documents.

FIG. 8 is a screenshot showing, by way of example, a further Web page for refining aggregates of documents.

FIG. 9 is a flow diagram showing, by way of example, a process for voting on ideas.

FIG. 10 is a screenshot showing, by way of example, a Web page for displaying ideas to a user.

FIG. 11 is a screenshot showing, by way of example, a Web page for displaying a list of aggregates.

FIG. 12 is a screenshot showing, by way of example, a Web page for displaying a list of ideas.

### DETAILED DESCRIPTION

Conventional idea management systems are often overloaded with ideas, which makes reviewing and revising the ideas difficult and time consuming. For example, ideas can be overlooked based on time limitations of individual users and can result in a reduced quality decision made by a networked business organization or community. An abundant overload of ideas can also overwhelm users and prevent them from adopting and participating in the idea submission process. Even more specifically, large numbers of ideas overwhelm the users who play the role of facilitator or moderator to facilitate the idea generation and selection process. To address this problem of idea overload, aggregation and deliberation of idea groups provides a two-level approach to give users efficient tools for aggregating ideas, and evaluating or voting on the aggregates of ideas.

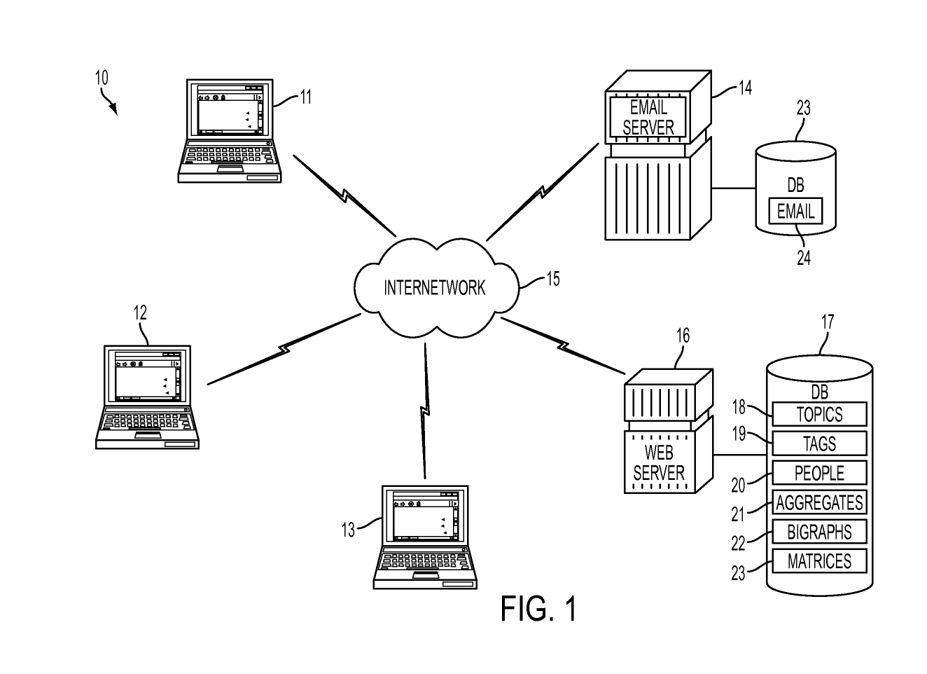

Collaborative idea group management requires a support environment within which aggregates of ideas can be generated and evaluated. FIG. 1 is a system for content tagging and distribution through email, in accordance with one embodiment. One or more user devices 11-13 are connected to an email server 14 via an Internetwork 15, such as the Internet. The user devices 11-13 can include a computer, laptop, or mobile device, such as a cellular telephone or personal digital assistant (not shown). In general, each user device 11-13 is a Web-enabled device that executes a Web browser and email program, which supports interfacing tools and information exchange with a Web server 16 and the email server 14.

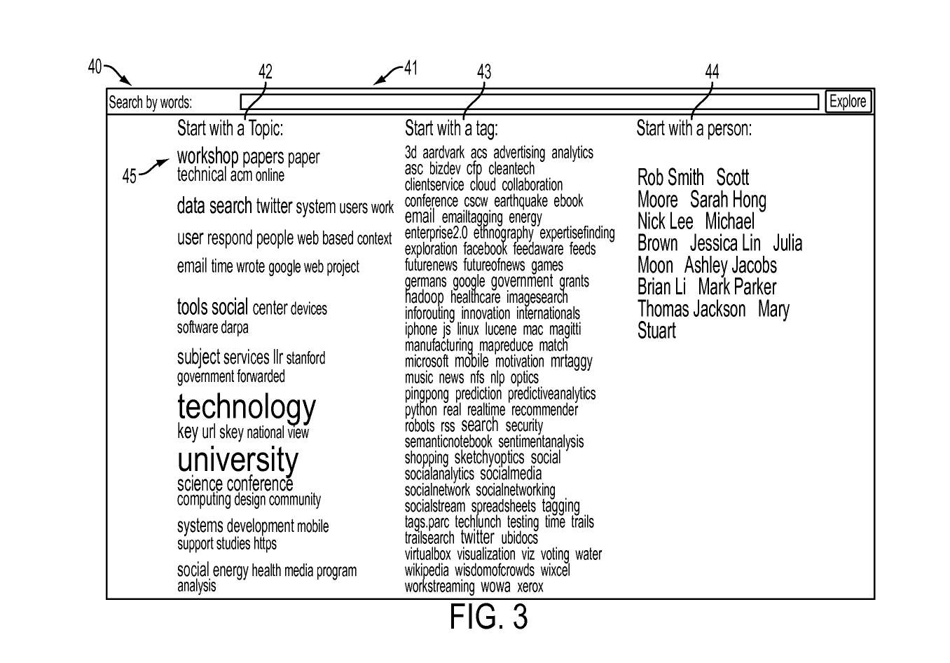

The email server 14 receives email messages 24 from one or more of the user devices 11-13. Each email message 24 includes content that represents an idea relevant to a particular business organization or civic community. Further, each email message 24 is associated with metadata, including topics 18, tags 19, people 20, and time (not shown). The metadata is extracted from the email messages and stored in a database 17 associated with the Web server 16, which provides a display of the metadata to the user devices 11-13 via a Web page, as described below with reference to FIG. 3. Alternatively, users can manually provide the metadata for storage with the document. Transmission of the email messages from a user device 11-13 to the email server 14 can occur through the Simple Mail Transfer Protocol, as well as other messaging protocols.

In a further embodiment, the ideas can be included in other short messages (not shown), including Tweets, text messages, Instant Messaging, or posts, such as on Facebook. Since ideas can also be provided in other mediums, the term document is intended to include email messages, text messages, Instant Messages, Tweets, and posts, unless otherwise indicated.

The documents 24 can be stored in the database 23 associated with the email server 14, the database 17 associated with the Web server 16, or in another database (not shown). The stored metadata 18-20 is used to generate a bigraph 22 that identifies relationships by associating documents with the corresponding metadata. The bigraph is expressed as a matrix and a spreading activation technique is applied, as described in commonly-owned U.S. Patent Application Publication No. 2008/0201320, pending, the disclosure of which is incorporated by reference, to identify the most interesting documents for a selected category of metadata, which is known as the initial entry vector. For example, for tags, a bigraph represented by a matrix can be filled with a probability that each tag is associated with one of the documents that represents the ideas. For topics, a Latent Dirichlet Allocation analysis is performed on the documents to identify the topics and subsequently, a matrix is generated to identify the probability that a document includes a particular topic.

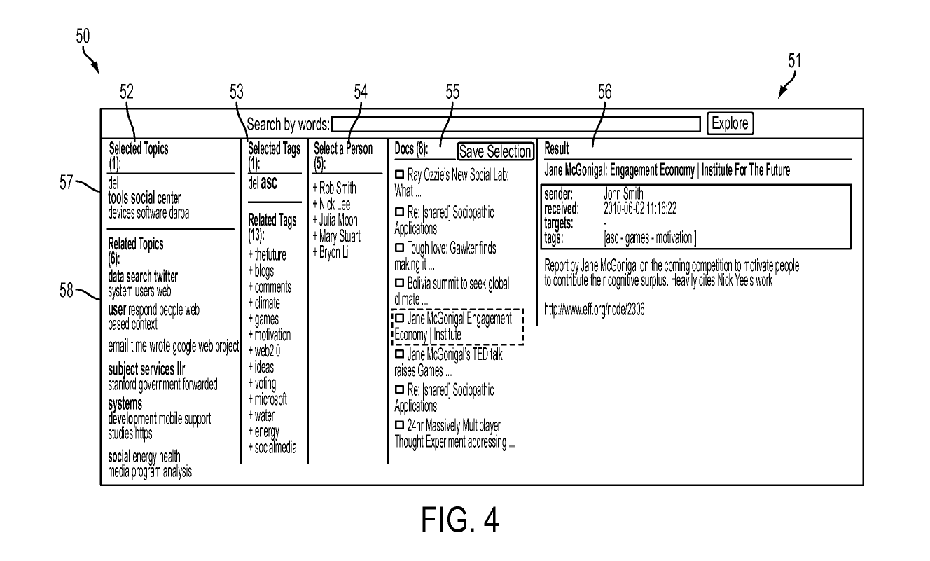

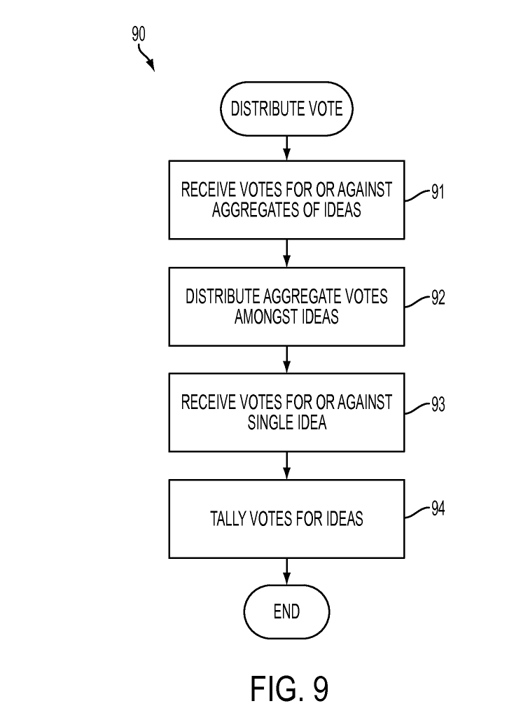

Using relationships identified by the bigraphs, a display of the metadata is organized by category and provided to a user via a user interface on at least one of the user devices 11-13 for selection of one or more items of metadata within one or more of the categories, as further described below with reference to FIG. 3. Once selected, documents related to the selected metadata items are identified and provided to the user, via a Web page, as an aggregate of ideas, which is further described below with reference to FIG. 4. The aggregates are stored and can be voted upon once all ideas have been submitted or on a rolling basis, which is described below with reference to FIG. 9. Formation of the aggregates helps to manage large amounts of ideas by organizing related ideas into groupings or clusters, which in turn helps to prevent cognitive overload by the users and can lead to identifying those ideas that are most aligned with the purpose and goal of the business organization or community for which the ideas are being considered.

The user devices 11-13 and servers 14, 16 can each include one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, either as integrated circuitry or burned into read-only memory components. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

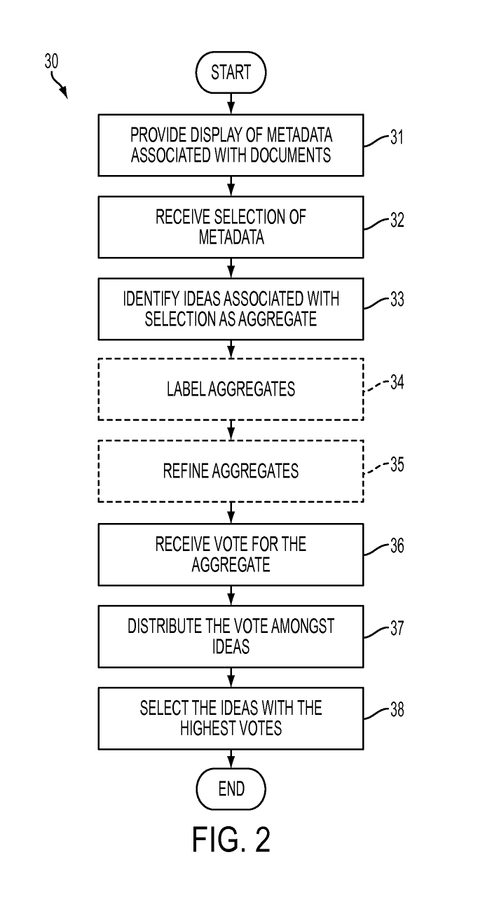

To ensure that the ideas most related to the objectives and goals of a business organization or civic community are considered, organization of the ideas into groups based on a particular business company or community is needed. FIG. 2 is a method for management and deliberation of idea groups, in accordance with one embodiment. Users that are associated with a particular business or organization can submit ideas via email, text messages, or posts, such as on Twitter or Facebook. The ideas can address one or more issues that are relevant to the organization or community. A display of metadata associated with the submitted ideas is provided (block 31) to one or more of the users in that organization or community. The metadata display can be automatically provided or provided based on a request from the user. The metadata can be organized by category and each category of metadata can be displayed as a list. Metadata items for each category can be represented as a cloud of or more items in which the more frequently occurring items of metadata are associated with a greater font size, highlighting, or different font style. FIG. 3 is a screenshot 40 showing, by way of example, a Web page 41 for displaying metadata 42-44 associated with documents that represent ideas. The documents can include the email, text, or post in which the idea was submitted. The metadata can include categories, such as topics 42, tags 43, people 44, and time (not shown). The metadata 42-44 associated with the documents can be determined via a mixed initiative approach, where a machine automatically determines the topics and time, while a user manually assigns the tags to the documents. In one embodiment, the tags can be assigned via a tag address, as described in commonly-assigned U.S. Patent Application Publication No. 2011/0191428, pending, the disclosure of which is incorporated by reference. Each email message is associated with a tag address, such as contenttag@tagserver.company.domain, which includes a content tag, an email server, and a domain. The tag address is parsed to identify the content tags and information is extracted from the email message, such as the content tags, personal email addresses, and email content for storage in a tag repository. Once processed, the email message can be directly transmitted to one or more users associated with the tag and identified via a user-to-tag association record. In a further embodiment, digests of incoming email messages can be distributed or the messages can be distributed based on triggers from other data sources.

Meanwhile, the topics can be automatically assigned to the documents using the Latent Dirichlet Allocation analysis, which is applied to the content or idea of a document. The time can be recorded or stamped when the document was transmitted, posted, or provided to one or more recipients. Meanwhile, the people associated with an idea provided in a document can include a sender or author, and one or more recipients. Other types of metadata are possible.

The Web page 41 displays each category of metadata 42-44, in a column, as a list of metadata items. The list of metadata items can be ordered alphabetically, by frequency of occurrence, or randomly, as well as by other ordering methods. In a further embodiment, metadata clouds can represent each metadata item. The metadata clouds each represent weighted words related to that metadata item in descending order. The words with the higher frequency of occurrence within the documents can be assigned a higher weight and are highlighted, bold, or have a larger font size or different font type. For example, the topic column 42 includes ten small clouds of topics, each having six individual words associated with that topic. In the first topic cloud, the first three terms “workshop,” “papers,” and “paper” have a larger font than the last three words “technical,” “acm,” and “online.” The number of words selected to represent each topic can be predetermined. Meanwhile, the same number of words can be selected to represent each topic or each topic can be represented by a different number of words.

The metadata items selected for display under each metadata category can be determined using the bigraphs and spreading activation technique described above with reference to FIG. 1. The number of metadata items associated with each metadata category can be predetermined, based on a threshold or can include all metadata items for that category. Other selections and displays of the metadata, such as the number of columns and clouds, are possible. For example, in one embodiment, the number of topics presented are predetermined and limited to ten. However, other numbers are possible. The ten topics can be identified using a topic modeling technique. Specifically, to generate the cloud representing each topic, a corpus of documents is analyzed and separated into 10 groupings, or clouds, based on a mutual similarity of the document content.

Returning to the discussion of FIG. 2, a user can manually organize at least a portion of the ideas by selecting (block 32) one or more items of metadata from one or more of the metadata categories. The ideas can be organized in a way that is meaningful to a particular organization or community. For instance, organization of the ideas can be based on a functioning of the organization or community, as well as their objectives and goals. Subsequently, documents representing ideas that are related to the selected metadata items are identified as an aggregate of ideas, which is displayed to the user (block 33) and stored. Hereinafter, the terms “aggregate of documents” and “aggregate of ideas” are used interchangeably with the same intended meaning, unless otherwise indicated. FIG. 4 is a screenshot 50 showing, by way of example, a Web page 51 for displaying aggregates of documents 55 based on selected topics 52 and tags 53. The Web page 51 includes five columns including a topics category 52, tags category 53, and person category 54 displayed from left to right. Within each of the columns, a first row 57 includes those metadata items that have been selected by a user. Additionally, a second row 58 includes those metadata items that are related to documents identified as being related to all of the selected metadata items. In the person category 54, no metadata item was selected and those items associated with the person category remain displayed. To the right of the person category 54, a document category 55 is displayed. The document category 55 represents an aggregate of documents, each of which have been identified as related to the selected metadata items. Specifically, each aggregate groups those documents that include ideas, which are related to the selected metadata items. In the right column, content 56 of one or more documents selected from the document category 55 is displayed to present the represented idea associated with that document.

The documents are identified using the spreading activation technique. For topics, documents can be identified by receiving a selection of a particular topic via a user and presenting only those documents that are most strongly related to the selected topic. In one embodiment, even though a document can be represented by multiple topics, the document may only be presented upon selection of one of the topics. The presented documents can be determined by applying a predetermined relatedness threshold to the documents for a selected topic and those documents with content that satisfy the threshold are presented. For tags and people, the spreading activation technique is used to determine what documents are associated with a selected tag or person. When metadata items are selected in more than one metadata category, spreading activation is run for each metadata item in each category and subsequently, those documents, which are identified for each selected metadata item, are selected for inclusion in the aggregate. Also, related topics, tags, and persons can be based on a semantic similarity of the document content associated with each topic, tag, or person. For example, related tags can be identified based on a content of the documents associated with each tag.

Also, overlapping aggregates of documents can be formed. For instance, referring to FIG. 4, one of the related topics 58 can be selected to replace the currently selected topic 57. The two topics are related and likely to share one or more documents in common. Thus, when displayed, the aggregates can be overlapping, rather than only mutually exclusive of one another.

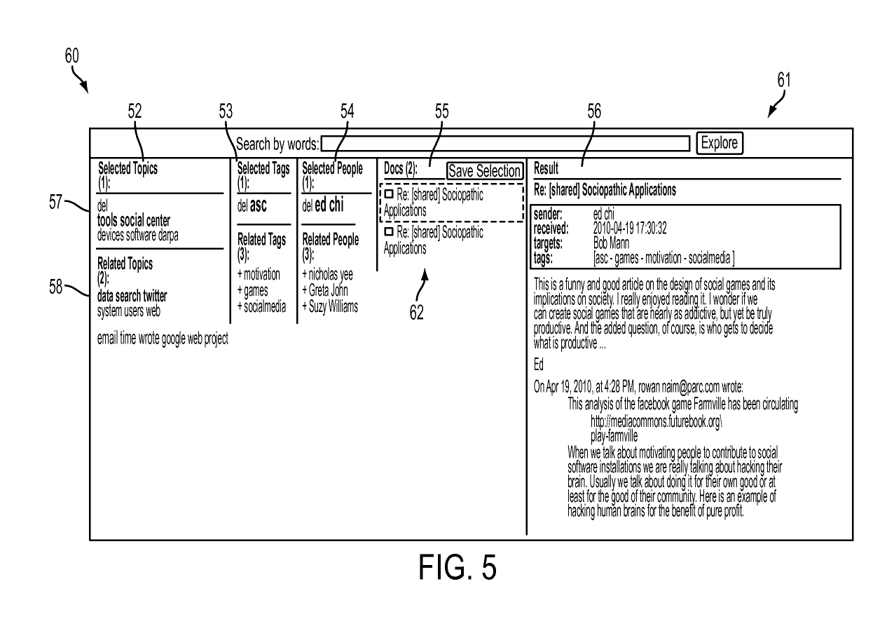

Generally, as more metadata items are selected, the number of relevant documents is reduced. For example, FIG. 5 is a screenshot 60 showing, by way of example, a Web page 61 for displaying a different aggregate of documents based on selected topics 52, tags 53, and people 54. One metadata item 57 from each of the topics 52, tags 53, and people 54 categories is selected. The number of documents 62 displayed is reduced from the number of documents displayed in FIG. 4 when only metadata items from the topics and tags category were selected. In a further embodiment, time can also be used as a metadata category to select relevant documents.

The users that select at least one of the metadata items or documents can be a customer, member, employee, or other interested individual of the organization or community. In a further embodiment, one or more facilitators can be selected from the users to generate the aggregates of ideas. A facilitator is an individual that is selected as being good judge of aggregates using the crowdsourcing method, which provides an open call to the users for filling the job of facilitator and gathers those users that are the best fit to perform the voting task. For example, users best fit to perform the voting task may be employees of the business organization or community or users having a deep understanding of the goals of the business organization or community to determine whether ideas are aligned with the goals. The facilitators should have the ability to allow the best ideas to surface and provide the most promising ideas for a vote.

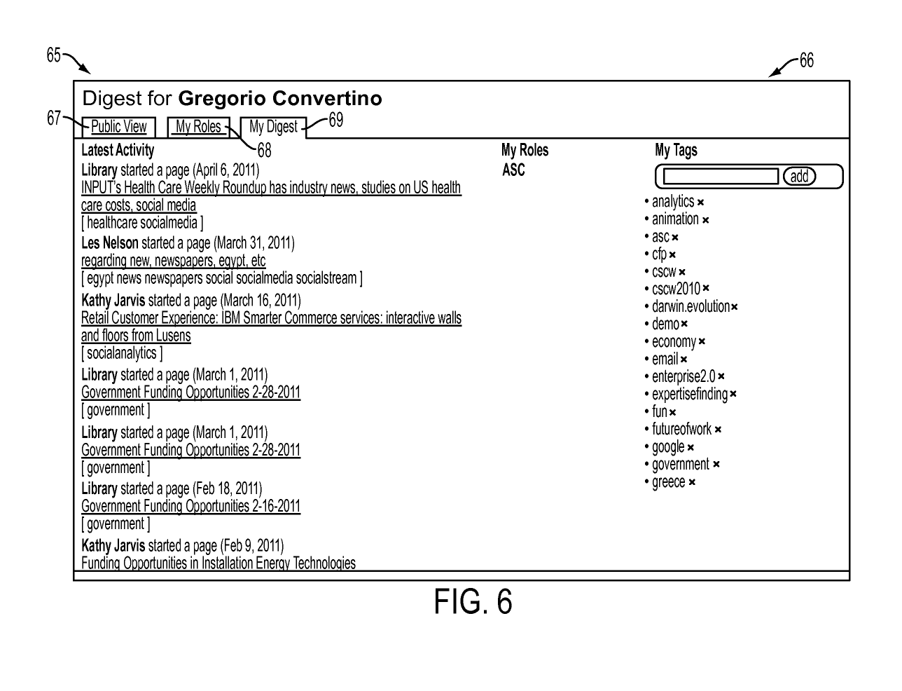

Facilitators can be selected based on an associated user profile. FIG. 6 is a screenshot 65 showing, by way of example, a Web page 66 for displaying a user profile. The profile can be built by automatically recording an interaction history of each user and includes three tabs for “public view,” 67 “my roles,” 68 and “my digest” 69. Other tabs are possible. The public view tab 67 displays the user's interactions with ideas that are provided for review by the whole organization. The “my roles” 68 tab includes roles of the user, such as that user's relationship within the organization or community. For example, a user may have a title of middle manager within a business organization and is also selected as a facilitator for refining and voting on aggregates. Further, the “my roles” 68 tab can include different roles within subgroups formed within the business organization or community. For instance, returning to the above example, the user may be part of a subgroup that focuses on building business relationships in China and within that subgroup the user is merely a member and holds no management role or facilitator role. The “my digest” 69 tab displays the profile of the user that includes a list of the user's activities, roles, and selected tags. Other selected metadata items can be displayed. The metadata items can be automatically determined as relevant to the user or alternatively, the user can manually specify what topics, tags, people, or ideas he intends to follow. The profiles can be used as a customizable filter for ideas.

The user profiles are used to select those users best suited to identify ideas most relevant to the goals and objective of an organization or community. Specifically, the facilitators can be selected based on their job role within the organization or community and expertise with regards to the aggregates. The job role can be determined via the “my roles” tab of the user profile. Generally, those users that hold job titles of middle manager or moderator are likely to be selected as facilitator. However, one or more members of the community or organization, such as the Chair or Chief Executive Officer, can determine the preferred job roles or titles.

Additionally, an expertise of the user can also be determined via the user profile. A user's expertise can be based on behavior or actions of the user around the individual ideas and aggregates. For instance, any action of the user with regards to the ideas and aggregates, such as submitting an idea, reviewing an idea or aggregate, or refining an aggregate can be recorded and stored in the user profile. As the user's interactions increase with the ideas and aggregates, the user's reputation also increases. The expertise can be measured on a scale or assigned a numerical value to represent a level of expertise. Guidelines for selecting one or more facilitators can be determined on behalf of the organization and community. For instance, the guidelines may specify that all users who have the job title of manager and who have a high level of expertise should be selected or invited to participate as facilitators. The facilitators can be selected across all issues for the organization or community or for a particular issue. Additionally, a user can hold the role of facilitator in the organization or community or within one or more subgroups of the organization or community.

The aggregates can be generated through a mixed initiative approach in which the users or facilitators select metadata associated with the documents to group the documents. As described above, the metadata is assigned automatically by a machine or manually by an individual user or facilitator. Additionally, clusters or aggregates of ideas can also be formed automatically based on the assigned metadata.

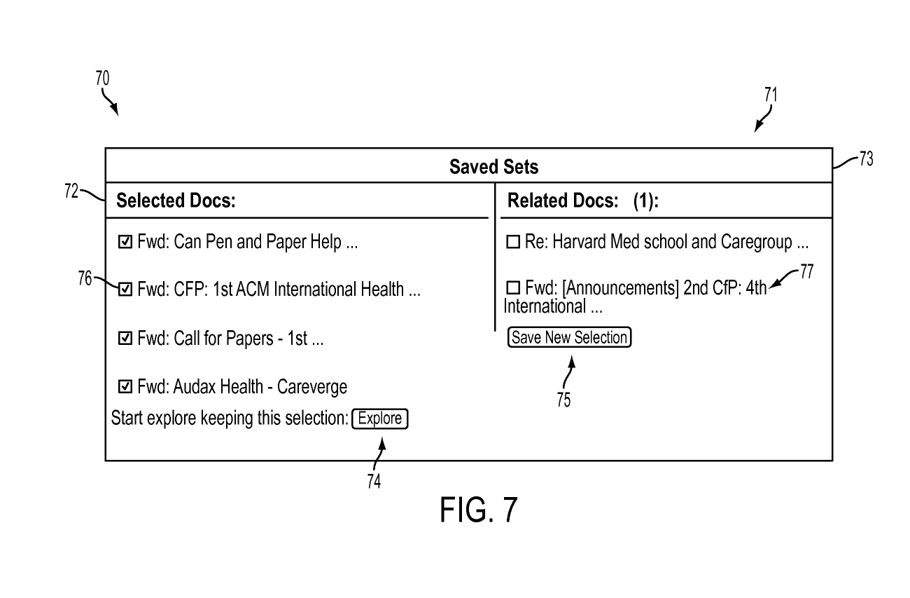

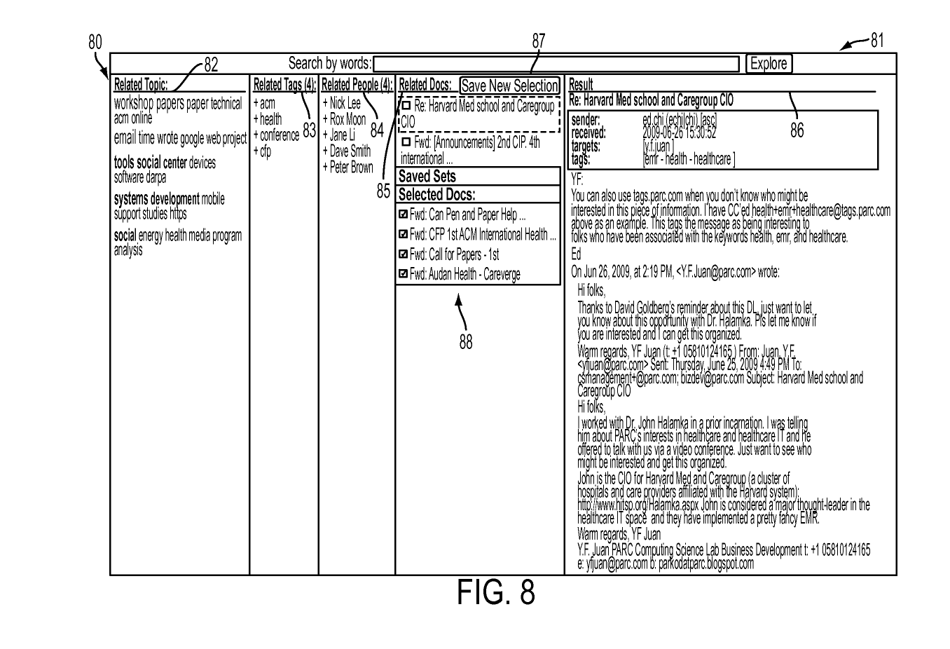

Returning to the discussion with respect to FIG. 2, the user or selected facilitator can optionally annotate (block 34) the aggregates of documents, such as by associating one or more labels with an aggregate. The label can include a name, theme, or describing characteristic of the aggregate. The annotation can be combined with the metadata and used during voting of the aggregates. Once generated and stored, the aggregates can be refined (block 35) to further organize the ideas for review and voting. Refinement can include adding new documents to the aggregates, as well as removing existing document. New documents can be added by reviewing other documents that are related to, but not included in the idea aggregate, or by performing an additional search for related documents that starts with the aggregate of documents to be refined. Refining the aggregate of documents is further described below with reference to FIGS. 7 and 8.

Further, the users or selected facilitators can optionally assign priorities to the aggregates to identify those aggregates with ideas most relevant to the organization or community. The priorities can be assigned based on a set of criteria related to the functioning of and goals of that organization or community and are used to filter the aggregates for identifying areas of ideas that are more important for the organization or community to determine the best ideas. The ideas that are aligned with the priorities of the organization or community are assigned a higher weight. For example, criteria can be generated for a particular organization based on that organization's interests and can include themes, such as cost reduction and expansion to a new market. However, the organization may be more interested in ideas regarding cost reduction, rather than expansion to a new market and an aggregate of ideas about cost reduction will have a higher weight than those ideas about market expansion. In one embodiment, a criteria table can be generated to identify a weight to be assigned to an aggregate based on a particular criteria associated with the business organization or community. The table can include criteria listed by column and aggregates listed by row. A weight is determined and listed for each criteria-aggregate pairing based on the priority assigned to that criteria and the aggregates relationship with the same criteria. In a further embodiment, a threshold can be applied to the weights to determine which aggregates should be presented for voting. Specifically, the threshold is applied to the weights and those aggregates with weights that satisfy the threshold are selected for presentation.

Once displayed, users or facilitators can vote (block 36) on the aggregates. Once the votes are received, each vote assigned to an aggregate is distributed (block 37) among the ideas represented by the documents. Distribution of the votes is further described below with reference to FIG. 9. Subsequently, the votes are tallied for each idea and one or more ideas with the highest tally of votes are selected (block 38) for further review, consideration, or implementation. For instance, a predetermined number of ideas with the highest vote tallies can be selected. Alternatively, a threshold number of votes can be applied to the ideas and only those ideas that satisfy the threshold are selected. As well, a single idea with the highest vote tally may be selected.

Prior to voting, the aggregates are refined to ensure that each aggregate includes a group of closely related ideas and that the best or more relevant ideas to the organization or community are presented. Further, refinement can also place newly-received ideas into stored aggregates. FIG. 7 is a screenshot 70 showing, by way of example, a Web page 71 for refining aggregates 72 of documents 76. An aggregate 72 of four documents 76 is shown on a left side 72 of the Web page 71 and documents 77 related to the aggregate are displayed on the right side 73 of the Web page 71. The related documents can be identified based on a semantic similarity to the documents of the aggregate. The semantic similarity can be determined using the content and metadata associated with each of the documents. A user or facilitator can review each of the related documents 77 and make a determination as to whether that document 77 should be included in the aggregate 72. If the related document is to be included, the user or facilitator can select a “save new selection” button 75. Otherwise, the document 77 remains in the related document column 73. If a further search for related documents is desired, the user or facilitator can select an “explore” button 74. The users and facilitators can refine aggregates of documents that they created or that others have created.

The further search for related documents can be conducted starting from one of the saved aggregates to be refined. FIG. 8 is a screenshot 80 showing, by way of example, a further Web page 81 for refining aggregates 88 of documents. The Web page 81 includes five columns with related topics 82, related tags 83, related people 84, related documents 85, and results 86, which are listed from left to right within the Web page 81. Other displays of the Web page are possible. In the related topics 82 column, topics that are related to the aggregate of documents are displayed. A cloud of words represents each related topic. In the related tags 83 column, tags that are related to the aggregate 88 of documents can be selected and displayed. The related people 84 column can include names or other identifiers of people that are related to the aggregate 88 of documents. The related metadata items selected for each metadata category can be determined using the matrices described above, along with the spreading activation technique.

A user or facilitator can select one or more of the metadata items to identify related documents, which are displayed in the related documents 85 column. A selected aggregate of documents 88 to be refined can be displayed below the related documents. The user or facilitator can select and review each of the related documents, which are displayed in the result column 86. If the related document is to be included in the aggregate 88, the user or facilitator can select a “save new selection” 87 button.

Upon refinement, the user or facilitator can assign a priority to one or more aggregates based on a relevance of the ideas in that aggregate to a particular organization or community. The assigned priorities can be used to determine which aggregates should be presented for voting to ensure that the best or most relevant ideas to that organization or community are considered. The users and facilitators can vote on the ideas once submitted, organized, and stored. FIG. 9 is a flow diagram showing, by way of example, a process 90 for voting on ideas for further consideration or implementation of that idea with an organization or community. The users or facilitators can vote on aggregates of ideas (block 91). Voting on the aggregates allows the users and facilitators to designate sets or themes of ideas that are aligned with specific objectives or trends for the business organization or civic community. Votes assigned to the aggregate are then distributed among the individual ideas in that aggregate (block 92). The votes can be distributed to ideas within an aggregate based on a reputation of an individual providing the vote and a centrality of each idea within the aggregate according to the equation below:

Vote(idea|aggregate)≈β1*reputation(user profile|aggregate)+β2*centrality(idea|aggregate) (1)

The reputation for a particular user submitting a vote can be based on a relationship between the user's profile and the aggregate that received the vote. Specifically, the reputation can be determined based on a semantic similarity of the user profile and content of a particular aggregate for which the vote is to be distributed. To determine the semantic similarity, the users' interactions with that aggregate, such as ideas submitted, aggregate reviewed, or aggregate refined are compared with the content of the ideas within the aggregate. Additionally, the user's reputation can also be partially determined based on the user's job role within the organization or community. A value or weight can be assigned to represent the user's reputation for the particular aggregate that received the vote. In one example, a user's profile shows many interactions with respect to ideas and aggregates focusing on transportation. Thus, the user's reputation with respect to one or more aggregates dealing with transportation is higher than with respect to aggregates dealing with health care.

Centrality is determined for each idea within the voted upon aggregate based upon a semantic similarity. The semantic similarity can analyze the content of an idea to determine a semantic centrality of that idea within an aggregate, along with any annotations, such as labels assigned to the aggregate, as described above with reference to FIG. 2. Specifically, the words of the idea are analyzed to determine a relationship of the words and annotations with the words and annotations of another idea in the aggregate. Those ideas with words that are similar to words of other ideas can be considered as more central than ideas having words that are different from other ideas. An idea that is considered to be central or more central than other words can receive a higher distribution of the vote. For each idea within the aggregate, the centrality of that idea is added to a value for the user's reputation to determine the portion of the vote assigned to the idea.

An example of distributing a vote among ideas of an aggregate includes receiving a vote for the aggregate, applying the equation to each idea within the aggregate by determining a reputation for the user, determining a centrality of the idea within the aggregate, and summing the values for centrality and reputation. Thus, if the aggregate includes four ideas, the equation is performed four separate times for each user that submits a vote for that aggregate.

The users and facilitators can also vote on individual ideas (block 93) for further consideration or implementation within that organization or community. In one embodiment, selected facilitators vote on the aggregates of ideas, while general users vote on the single ideas. However, other voting schemes are possible, such as allowing the users and facilitators to vote on the aggregates and ideas. The ideas presented individually can include those ideas from the aggregates or alternatively, can include additional ideas not in the aggregates. Also, the votes can be for or against one or more ideas or aggregates. Once received, the votes are tallied (block 94) for each idea to determine those ideas that are the most relevant to the objectives of the organization or community for which the vote is being conducted.

Once a vote has been conducted, the aggregates remain stored for further use by the organization or community. The stored and refined aggregates can be used to determine where the interests of the organization or community reside and can be refined over time to represent ideas that are relevant to the organization or community. The users or facilitators that refine the aggregates of ideas learn the concepts, themes, or areas of ideas that are relevant. For example, over an extended period of time, a trend can be identified as to how certain ideas will be grouped. Thus, once new ideas are received, a recommendation for inclusion in an aggregate can be made based on the saved and refined aggregates. For example, the content of a new idea is analyzed and determined to have an 80% chance of belonging to a particular aggregate based on a similarity or relevancy of that idea to the other ideas in the aggregate. Thus, a recommendation to group that idea with the aggregate is made to the user or facilitator. Additionally, a predetermined threshold can be applied to the relevancy score and an aggregate can be recommended for inclusion of the aggregate or the aggregate can be automatically included in the aggregate when the threshold is satisfied.

Further, a business organization or community can reuse the ideas of the stored aggregates by transferring knowledge. For example, ideas provided for a particular issue, such as a 2010 campaign, may be used, reviewed, or considered for a 2011 campaign. Further, assignments of priority described with reference to FIG. 4 can be used to identify and organize groups of ideas that are most promising or interesting to the organization or community based on their goals and objectives. Returning to the above example, during the 2010 campaign, ideas regarding job creation were highly prioritized, while ideas about salary increases had a lower priority. The ideas to be reused during the 2011 campaign can be selected based on the priority of the ideas assigned during the 2010 campaign and some ideas may be reused, while others will not.

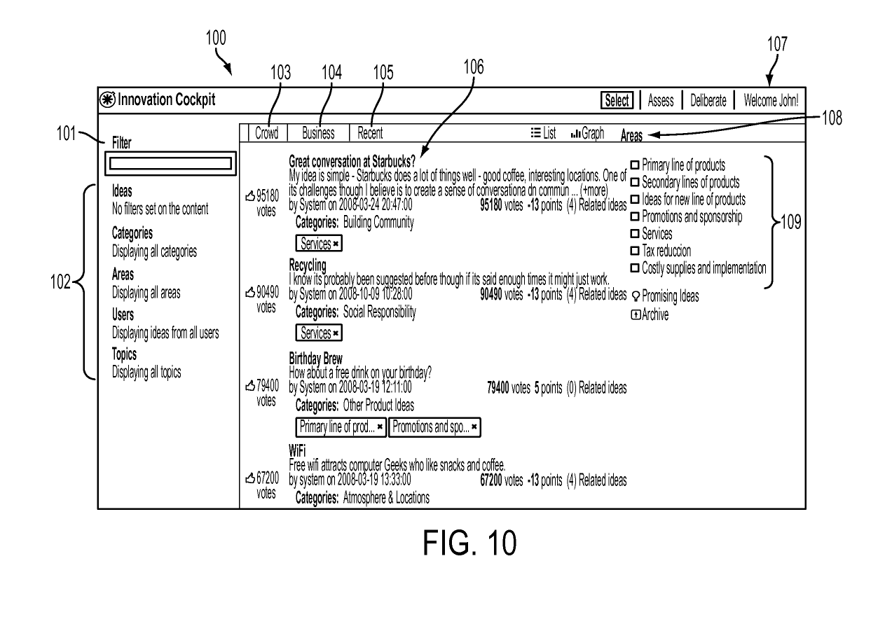

In a further embodiment, users can form aggregates of documents via tagging of the individual documents, which are filtered using metadata categories and elements. Additionally, individual users associated with particular ideas or aggregates can be displayed. FIG. 10 is a screenshot showing, by way of example, a Web page 100 for displaying ideas 106 to a user. An identity 107 of the user can be displayed on a top left corner of the Web page 100. The Web page includes a filter for identifying the ideas 106 by categories of metadata 102. The categories can include ideas, tag categories, areas, users, and topics. The idea metadata category can include keywords for searching against the text of each idea, while the tag categories include predefined and fixed tags associated with the ideas at the moment of submission, and the areas include saved aggregates of documents defined by a user, facilitator, or analyst after submission of the ideas. The user enters one or more terms into a search box displayed underneath the filter. Each term entered is associated with an element in one or more of the metadata categories. Ideas associated with the metadata element are then displayed in a center of the Web page 100 under a tab titled “Crowd.”

A group of individuals can form the crowd within which the ideas are provided. Once submitted, the ideas can be displayed with increasing or decreasing popularity based on a number of votes from the crowd or population of regular users. Other displays of the ideas are possible. The facilitator or analyst can tag one of the ideas by assigning that idea to one of the areas 108 listed on a right side of the Web page 100. Each area can be a folder in which the assigned ideas are stored as an aggregate of ideas. Alternatively, the area can include text descriptive of the associated aggregate, which can be assigned as a tag to each idea in that aggregate. The areas can be created or pre-selected by a facilitator or manager, as well as by other officers of the organization or committee, or by other qualified individuals associated with that organization or committee. Additionally, the areas can be generated based on prior knowledge learned from ideas received in the past that are determined to be aligned with the goals or objectives of the organization or community.

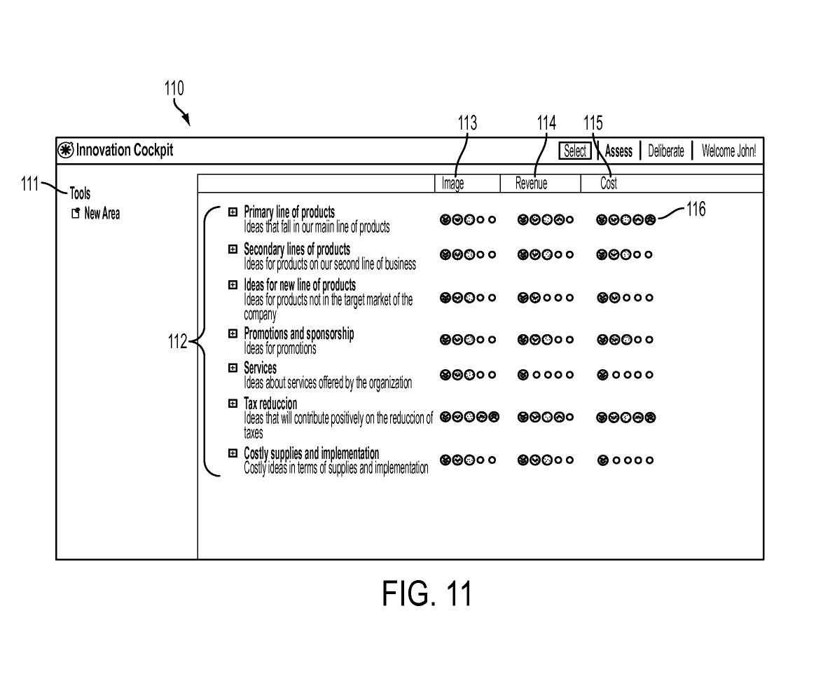

The user can move to a Web page displaying a list of the aggregates by selecting a business tab 104 located in a center of the Web page 104 or to a Web page displaying recently submitted ideas by selecting a recent tab 105. FIG. 11 is a screenshot showing, by way of example, a Web page 110 for displaying a list of aggregates 112. The aggregates 112 displayed can each be associated with a score or other measurement of a relationship to evaluation criteria that correspond to the goals and objectives of a business organization or community. For instance, the effect of an aggregate on evaluation criteria, such as an image of 113, revenue of 114, and cost to 115 the organization or community can be measured using a scale 116 that can include an absolute number, symbols, such as a “thumbs up” or “thumbs down,” or positive or negative signs. The scale 116 can reflect a positive or negative effect of the aggregate on each of the image, revenue, and cost to that organization or community. Other factors associated with the organization or community can be measured, such as retention of employees, publicity, or expansion. Additionally, each listed aggregate can include a title or text descriptive of the ideas in the aggregate, as well as a brief summary of the ideas. Further, each aggregate can be associated with one or more users, such as facilitators or general users. The associated facilitators can include the facilitators that helped generate the aggregate, that vote for the aggregate, or that submitted ideas to the aggregates. Meanwhile, the general users can include those users that have interacted with the ideas within the aggregate, which can be determined from the user profile. In one embodiment, the general users are selected to help the facilitators, such as by providing knowledge of the aggregate. The facilitators and general users can be listed in individual boxes, as bullet points, or as a pop up. The facilitators can be distinguished from the general users via color, highlighting, or font size. Other displays are possible.

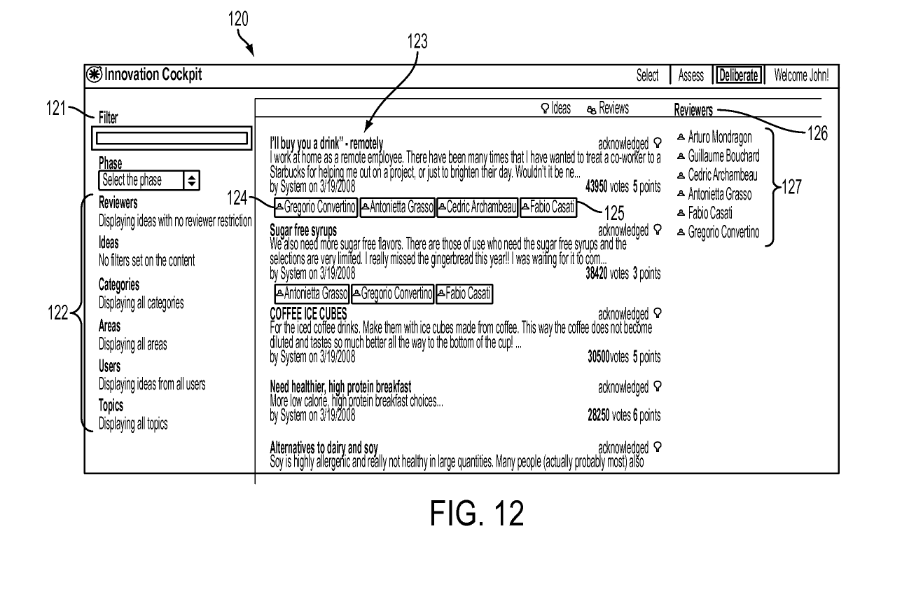

Users can also be associated with individual ideas. FIG. 12 is a screenshot showing, by way of example, a Web page 120 for displaying a list of ideas 123. The idea can be selected via a filter 121 using metadata categories 122, as described above with reference to FIG. 10 and displayed on a left side of the Web page 120. Each of the listed ideas can include a title or descriptive text of the idea, a number of votes, a number of points, and the textual content of the idea, as well as the user that submitted the idea and the date of submission. Additionally, each idea can be associated with one or more users, including facilitators 124 or general users 125, as described above with reference to FIG. 11. The facilitators 124 and general users 125 can be listed in individual boxes, as bullet points, or as a pop up. Other displays are possible. On a left side of the Web page 120, a list 126 of the users 127, or reviewers, can be presented by name, as well as by other identifiers, such as identification number or nickname.

While the invention has been particularly shown and described as referenced to the embodiments thereof, those skilled in the art will understand that the foregoing and other changes in form and detail may be made therein without departing from the spirit and scope of the invention.

What is claimed is:

1. A system for management and deliberation of idea groups, comprising:
ideas each associated with metadata;
a grouping module to group the ideas into aggregates based on the associated metadata;
a voting module to receive a vote for at least one of the aggregates from one or more users;
a distribution module to distribute the vote among the ideas in that aggregate based on a reputation of the user providing the vote and a centrality measure of each idea in the aggregate; and
a processor to execute the modules.

2. A system according to claim 1, further comprising:
a vote tallying module to receive votes on one or more of the ideas, to tally the votes assigned to each of the ideas, and to select a least one of the ideas for one or more of consideration, review, or implementation based on the tallied votes.

3. A system according to claim 1, further comprising:
profiles for the users; and
a selection module to select the user based on the user profile.

4. A system according to claim 1, further comprising:
a comparison module to compare the user profiles to textual content of each idea; and
a recommendation module to recommend at least one of the users for association with one or more of the aggregate and one of the ideas in the aggregate based on the comparison.

5. A system according to claim 1, wherein the metadata comprises at least one of topics, tags, people, and time.

6. A system according to claim 1, further comprising:
a refining module to refine the aggregates, comprising at least one of:
a presentation module to present other documents that are related to, but not included in the idea aggregate, and to select one of the other documents for inclusion in the aggregate; and
a search module to perform an additional search for related documents that start with at least one of the aggregates of documents to be refined and to select one of the related documents for inclusion in the aggregate.

7. A system according to claim 1, further comprising:
a label assigned to at least one of the aggregates.

8. A system according to claim 7, further comprising:
a centrality determination module to measure the centrality of the ideas based on content of the idea, the assigned label, and the metadata associated with that idea.

9. A system according to claim 1, wherein the ideas are received via at least one of an email, text message, instant message, and post.

10. A system according to claim 1, further comprising:
an idea grouping module to receive one or more metadata items selected by the user and to group the ideas based on the selected metadata items.

11. A system according to claim 1, further comprising:
a recommendation module to provide recommendations for grouping newly-received ideas into one or more aggregates.

12. A method for management and deliberation of idea groups, comprising:
managing ideas, each associated with metadata;
grouping the ideas into aggregates based on the associated metadata;
receiving a vote for at least one of the aggregates from one or more users; and
distributing the vote among the ideas in that aggregate based on a reputation of the user providing the vote and a centrality measure of each idea in the aggregate.

13. A method according to claim 12, further comprising:
receiving votes on one or more of the ideas;
tallying the votes assigned to each of the ideas; and
selecting a least one of the ideas for one or more of consideration, review, or implementation based on the tallied votes.

14. A method according to claim 12, further comprising:
maintaining profiles for the users; and
selecting the user based on the user profile.

15. A method according to claim 12, further comprising:
comparing the user profiles to textual content of each idea; and
recommending at least one of the users for association with one or more of the aggregate and one of the ideas in the aggregate based on the comparison.

16. A method according to claim 12, wherein the metadata comprises at least one of topics, tags, people, and time.

17. A method according to claim 12, further comprising:
refining the aggregates, comprising at least one of:
presenting other documents that are related to, but not included in the idea aggregate, and selecting one of the other documents for inclusion in the aggregate; and
performing an additional search for related documents that start with at least one of the aggregates of documents to be refined and selecting one of the related documents for inclusion in the aggregate.

18. A method according to claim 12, further comprising:
assigning a label to at least one of the aggregates.

19. A method according to claim 18, further comprising:
measuring the centrality of the ideas based on content of the idea, the assigned label, and the metadata associated with that idea.

20. A method according to claim 12, further comprising:
receiving the ideas via at least one of an email, text message, instant message, and post.

21. A method according to claim 12, further comprising:
receiving one or more metadata items selected by the user; and
grouping the ideas based on the selected metadata items.

22. A method according to claim 12, further comprising:
providing recommendations for grouping newly-received ideas into one or more aggregates.
